(19) United States
(12) Patent Application Publication
(10) Pub. No.: US 2026/0084653 A1
(43) Pub. Date: Mar. 26, 2026

(54) VEHICLE CONTROL DEVICE

(71) Applicant: TOYOTA JIDOSHA KABUSHIKI KAISHA, Toyota-shi (JP)

(72) Inventors: Hiroki TAKEISHI, Machida-shi (JP); Reina YAMAMURA, Nagoya-shi (JP); Ryosuke TANIMURA, Nagoya-shi (JP)

(73) Assignee: TOYOTA JIDOSHA KABUSHIKI KAISHA, Toyota-shi (JP)

(21) Appl. No.: 19/303,114

(22) Filed: Aug. 18, 2025

(30) Foreign Application Priority Data
Sep. 26, 2024 (JP) 2024-167728

(51) Int. Cl. B60R 25/24; B60R 25/04; B60R 25/30; G06Q 40/03

(52) U.S. Cl. CPC B60R 25/241; B60R 25/04; B60R 25/30; G06Q 40/034; G06Q 40/038

(57) ABSTRACT

A vehicle control device includes one or more processors. When a prespecified first requirement is met, the one or more processors activate engine start lock that prohibits starting of an engine of a vehicle. After activating the engine start lock, the one or more processors acquire a second request for deactivating the engine start lock from a user of the vehicle who is different from an owner of the vehicle. When the second request is acquired, the one or more processors determine whether to permit deactivation of the engine start lock based on a predetermined condition. When it is determined to permit deactivation of the engine start lock, the one or more processors deactivate the engine start lock.

### CROSS-REFERENCE TO RELATED APPLICATION

This application claims priority to Japanese Patent Application No. 2024-167728 filed on Sep. 26, 2024. The disclosure of the above-identified application, including the specification, drawings, and claims, is incorporated by reference herein in its entirety.

### BACKGROUND

### 1. Technical Field

This disclosure relates to a vehicle control device.

### 2. Description of Related Art

Japanese Patent No. 6647509 (JP 6647509 B) discloses a technology by which, for reasons of credit protection or safety, an individual or a corporation (e.g., an owner of a vehicle) other than a user of the vehicle executes engine start lock that prohibits starting of the engine.

### SUMMARY

The technology disclosed in JP 6647509 B may cancel (deactivate) the engine start lock in the case where, after the owner of the vehicle has activated the engine start lock, the user has no other choice but to use the vehicle for use in daily life, such as commuting or visiting hospitals. This is because if the user is not allowed to minimally use the vehicle in daily life, the user falls further behind in payment of a debt, which is disadvantageous for the owner as well.

However, if the engine start lock is unconditionally canceled after the engine start lock has been activated, the owner's purpose, such as credit protection, cannot be accomplished. Thus, the technology disclosed in JP 6647509 B has room for improvement in terms of reconciling minimum use of the vehicle by the user and credit protection by the owner with each other.

This disclosure provides a vehicle control device that can reconcile minimum use of the vehicle by the user and credit protection by the owner.

A vehicle control device according to a first aspect of this disclosure includes one or more processors. When a prespecified first requirement is met, the one or more processors activate engine start lock that prohibits starting of an engine of a vehicle. After activating the engine start lock, the one or more processors acquire a second request for deactivating the engine start lock from a user of the vehicle who is different from an owner of the vehicle. When the second request is acquired, the one or more processors determine whether to permit deactivation of the engine start lock based on a predetermined condition. When it is determined to permit deactivation of the engine start lock, the one or more processors deactivate the engine start lock.

This disclosure makes it possible to reconcile minimum use of the vehicle by the user and credit protection by the owner.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing the general configuration of a vehicle control system including a vehicle control device according to an embodiment;

FIG. 2 is a sequence chart showing one example of exchange of information among a lock cancelation application device, a credit collection server, a vehicle information server, and a vehicle;

FIG. 3 is a flowchart showing one example of the flow of a process in the credit collection server that functions as the vehicle control device according to the embodiment;

FIG. 4 is a flowchart showing one example of a flow in the vehicle information server when transmitting vehicle information to the credit collection server;

FIG. 5 is a flowchart showing one example of a flow in the vehicle information server when performing activation of engine start lock;

FIG. 6 is a flowchart showing one example of a flow in the vehicle information server when performing cancelation of the engine start lock;

FIG. 7 is a flowchart showing one example of a flow in the vehicle when transmitting the vehicle information to the vehicle information server;

FIG. 8 is a flowchart showing one example of a flow in the vehicle when performing activation of the engine start lock;

FIG. 9 is a flowchart showing one example of a flow in the vehicle when performing cancelation of the engine start lock; and

FIG. 10 is a flowchart showing one example of a flow in the lock cancelation application device when performing cancelation of the engine start lock.

### DETAILED DESCRIPTION OF EMBODIMENTS

A vehicle control device according to an embodiment of this disclosure will be described with reference to the drawings. Constituent elements in the following embodiment include those that a person skilled in the art can easily substitute, or those that are substantially the same.

### Vehicle Control System

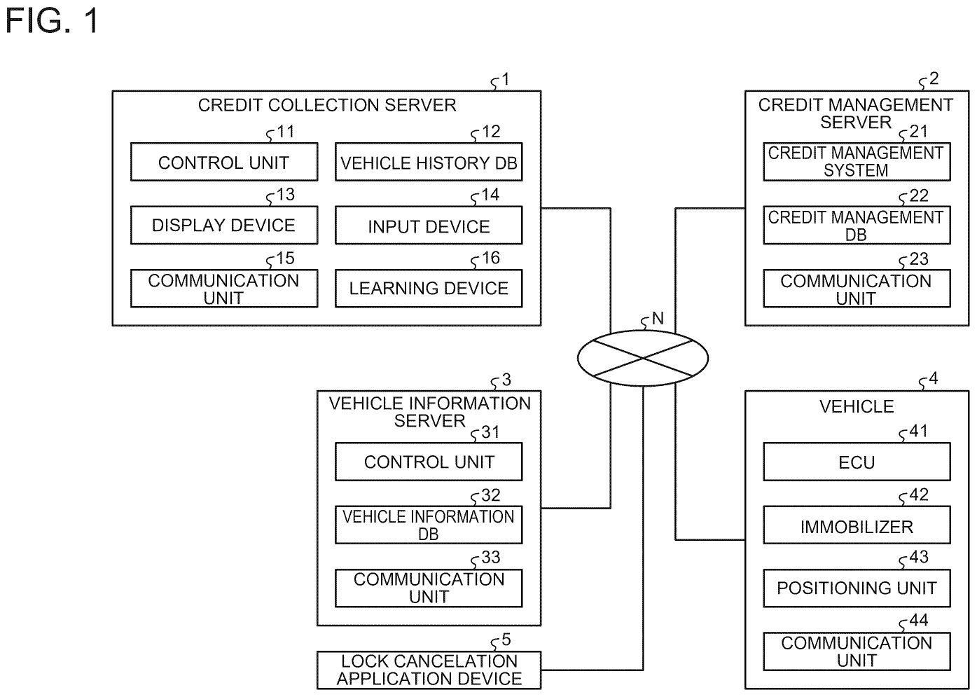

A vehicle control system according to the embodiment will be described with reference to FIG. 1. As shown in FIG. 1, the vehicle control system has a credit collection server 1, a credit management server 2, a vehicle information server 3, a vehicle 4, and a lock cancelation application device 5. The credit collection server 1, the credit management server 2, the vehicle information server 3, the vehicle 4, and the lock cancelation application device 5 each include a communication function, and are configured to be able to exchange various pieces of information by communicating with one another through a network N. The network N is formed by, for example, a public line network, such as an Internet network or a mobile phone network. In the vehicle control system according to the embodiment, the credit collection server 1 functions as a vehicle control device that controls operation of the vehicle 4, particularly engine start lock that prohibits starting of the engine. In this disclosure, “cancelation” and “deactivation” are synonymously used.

### Credit Collection Server

The credit collection server 1 remotely controls the vehicle 4 to collect a credit relating to the vehicle 4. In this embodiment, examples of “credit” include a credit relating to an installment contract at the time of purchase of a vehicle, a credit relating to a lease contract of the vehicle 4, a credit relating to a subscription contract of the vehicle 4, and a credit relating to a rental contract of the vehicle 4.

A creditor in this embodiment is, for example, an owner (possessor) of the vehicle 4. Examples of the creditor include a dealer of the vehicle 4 and a credit company. A debtor in this embodiment is, for example, a user of the vehicle 4. Examples of the debtor include a purchaser of the vehicle 4 and a party to a contract, such as a lease contract.

As shown in FIG. 1, the credit collection server 1 includes a control unit 11, a vehicle history DB 12, a display device 13, an input device 14, a communication unit 15, and a learning device 16.

The control unit 11 is realized by, for example, a processor that is formed by a central processing unit (CPU) or the like and a memory (main storage unit) that is formed by a random access memory (RAM), a read-only memory (ROM), or the like. When the vehicle 4 meets a prespecified requirement for the engine start lock (hereinafter referred to as “engine start lock requirement”), the control unit 11 activates the engine start lock of the vehicle 4. When the engine start lock is activated, starting of the engine is prohibited.

Examples of the engine start lock requirement include that the user of the vehicle 4 defaults on a debt (is late in payment). Determination as to whether this engine start lock requirement is met is performed, for example, in the credit management server 2. When there is a vehicle 4 that meets the engine start lock requirement, information for identifying that vehicle 4 (e.g., a vehicle identification number (VIN number)) is transmitted from the credit management server 2 to the credit collection server 1.

Specifically, the control unit 11 acquires information about the vehicle 4 that meets the engine start lock requirement from a credit management system 21 of the credit management server 2. Subsequently, the control unit 11 activates the engine start lock and prohibits starting of the engine by controlling an immobilizer 42 of the vehicle 4 through the vehicle information server 3.

After activating the engine start lock, according to a request for cancelation (deactivation) of the engine start lock from the user of the vehicle 4 who is different from the owner of the vehicle 4, the control unit 11 determines whether to permit cancelation of the engine start lock of the vehicle 4 based on predetermined conditions. When the control unit 11 determines to permit cancelation of the engine start lock, the control unit 11 cancels the engine start lock by controlling the immobilizer 42 of the vehicle 4 through the vehicle information server 3.

Here, a request for cancelation of the engine start lock may be acquired, for example, from an information processing terminal of the owner of the vehicle 4. This refers to, for example, a case where a request for use of the vehicle 4 is made from the user of the vehicle 4 to the owner thereof while the engine start lock is on, and the owner makes a request for cancelation of the engine start lock through his or her own information processing terminal.

Examples of “information processing terminal” in this case include the credit collection server 1 and the lock cancelation application device 5. A case where the information processing terminal is the credit collection server 1 refers to a case where activation and cancelation of the engine start lock are performed by the same terminal (a person in charge of activation of the engine start lock and a person in charge of cancelation thereof are the same). A case where the information processing terminal is the lock cancelation application device 5 refers to a case where activation and cancelation of the engine start lock are each performed by a different terminal (a person in charge of activation of the engine start lock and a person in charge of cancelation thereof are different).

Alternatively, a request for cancelation of the engine start lock may be acquired from an information processing terminal of the user of the vehicle 4. This refers to, for example, a case where, while the engine start lock is on, the user of the vehicle 4 makes a request for cancelation of the engine start lock through his or her own information processing terminal. Examples of “information processing terminal” in this case include the lock cancelation application device 5.

Examples of the predetermined conditions for canceling the engine start lock include a time when cancelation of the engine start lock is to be executed, a position and a route of the vehicle 4 where cancelation of the engine start lock is to be executed, and the number of times that the engine start lock has been canceled.

The predetermined conditions for canceling the engine start lock may include a condition about a clock time or a period when the engine start lock is to be canceled. In this case, when the clock time or the period when the engine start lock is to be canceled is within a predetermined time, the control unit 11 permits cancelation of the engine start lock and cancels the engine start lock through the vehicle information server 3.

Examples of “when a clock time when the engine start lock is to be canceled is within a predetermined time” include the following:
(1) when a clock time when the control unit 11 has acquired a request for cancelation of the engine start lock from the lock cancelation application device 5 is within a predetermined time
(2) when the control unit 11 acquires information about “a clock time when cancelation of the engine start lock is desired” at the same time as acquiring a request for cancelation of the engine start lock from the lock cancelation application device 5, and this clock time is within a predetermined time

“Predetermined time” is, for example, a time when the user habitually uses the vehicle 4 on a routine basis, and examples thereof include the following:
(1) time from leaving home to arriving at office (e.g., 7 a.m. to 9 a.m.)
(2) time from leaving office to coming home (e.g., 5 p.m. to 7 p.m.)
(3) time from arriving at office from home to coming home (e.g., 7 a.m. to 7 p.m.)
(4) time from leaving home to arriving at hospital
(5) time from leaving hospital to arriving at home
(6) time from visiting hospital from home to coming home

Examples of “when a period when the engine start lock is to be canceled is within a predetermined time” include a case where a request for cancelation of the engine start lock includes information about “a period when cancelation of the engine start lock is desired,” and this period is within a predetermined time. A period when cancelation of the engine start lock is desired may include a clock time when cancelation of the engine start lock is to be started and a clock time when cancelation of the engine start lock is to be ended.

The predetermined conditions for canceling the engine start lock may include a condition about a position of the vehicle 4. In this case, when the position of the vehicle 4 is a predetermined position, the control unit 11 permits cancelation of the engine start lock and cancels the engine start lock through the vehicle information server 3. “Predetermined position” is a position where the user of the vehicle 4 habitually parks the vehicle 4 on a routine basis, and examples thereof include home, a workplace, and a hospital.

The predetermined conditions for canceling the engine start lock may include information about a route from a current position of the vehicle 4 to a destination. Examples of “a route from a current position of the vehicle 4 to a destination” include a route to go from home to a workplace or a hospital and a route to go back to home in daily life. In this case, the control unit 11 acquires information about “a route from a current position of the vehicle 4 to a destination” at the same time as acquiring a request for cancelation of the engine start lock from, for example, the lock cancelation application device 5. When the vehicle 4 has traveled outside a predetermined range from the aforementioned route after cancelation of the engine start lock, the control unit 11 activates the engine start lock again through the vehicle information server 3. In other words, when the vehicle 4 has traveled farther than a predetermined distance from the aforementioned route, the engine start lock is activated. That is, when the vehicle 4 has deviated significantly from the route to the destination, the control unit 11 determines that the use is for an unintended purpose and executes the engine start lock again.

The predetermined conditions for canceling the engine start lock may include information about a required time from a current position of the vehicle 4 to a destination. In this case, the control unit 11 acquires information about “a required time from a current position of the vehicle 4 to a destination” at the same time as acquiring a request for cancelation of the engine start lock from, for example, the lock cancelation application device 5. When the vehicle 4 has traveled beyond a predetermined time relative to the required time after cancelation of the engine start lock, the control unit 11 activates the engine start lock again through the vehicle information server 3. That is, when there is a significant deviation from the required time to the destination, the control unit 11 determines that the use is for an unintended purpose and executes the engine start lock again.

The predetermined conditions for canceling the engine start lock may include information about the number of times that the engine start lock has been canceled. In this case, when the number of times that the engine start lock has been canceled during a predetermined period is equal to or smaller than a predetermined number of times, the control unit 11 permits cancelation of the engine start lock and cancels the engine start lock through the vehicle information server 3. Examples of “a predetermined number of times” include once a day and twice a day.

Determining whether to permit cancelation of the engine start lock based on the predetermined conditions in the control unit 11 may include determining whether it is necessary to permit cancelation of the engine start lock using a technique of machine learning.

In this case, information about the vehicle 4 (hereinafter referred to as “vehicle information”) that is contained in the vehicle history DB 12 is learned beforehand in the learning device 16. Examples of “vehicle information” include the following:
(1) a current or past parking position of the vehicle 4
(2) a current or past travel route of the vehicle 4
(3) a clock time or a period when the engine start lock of the vehicle 4 was canceled in the past
(4) the number of times (the number of times per day) that the engine start lock of the vehicle 4 was canceled in the past

The learning device 16 generates a machine learning model through training using, as a feature amount, the clock time or the period when the engine start lock of the vehicle 4 was canceled in the past and, as a correct label, information about whether to permit cancelation of the engine start lock (training phase).

The learning device 16 may generate a machine learning model through training using, as a feature amount, other than the clock time or the period when the engine start lock of the vehicle 4 was canceled in the past, the current or past parking position of the vehicle 4, the current or past travel route of the vehicle 4, or the number of times (the number of times per day) that the engine start lock of the vehicle 4 was canceled in the past, and, as a correct label, the information about whether to permit cancelation of the engine start lock. In this case, the learning device 16 may train using, as a feature amount, at least one of the current or past parking position of the vehicle 4, the current or past travel route of the vehicle 4, the clock time or the period when the engine start lock of the vehicle 4 was canceled in the past, and the number of times (the number of times per day) that the engine start lock of the vehicle 4 was canceled in the past, or may train using, as a feature amount, at least one of the current or past parking position of the vehicle 4, the current or past travel route of the vehicle 4, and the number of times (the number of times per day) that the engine start lock of the vehicle 4 was canceled in the past in addition to the clock time or the period when the engine start lock of the vehicle 4 was canceled in the past. The technique of machine learning that the learning device 16 uses is not particularly limited, and various techniques can be used, such as deep learning using a neural network, a support vector machine, a random forest, or a k-nearest neighbor algorithm.

Subsequently, the control unit 11 determines whether to permit cancelation of the engine start lock by inputting a clock time or a period when the engine start lock is to be canceled into the machine learning model having been generated as described above (prediction phase).

The vehicle history DB 12 is a database that stores the above-described vehicle information.

The display device 13 is realized by, for example, a liquid crystal display (LCD) or an organic EL display (OLED). The input device 14 is realized by, for example, a keyboard or a pointing device.

The communication unit 15 is composed of, for example, a local area network (LAN) interface board, a wireless communication circuit for wireless communication, etc. The communication unit 15 exchanges information with the credit management server 2, the vehicle information server 3, and the lock cancelation application device 5 through communication via the network N.

### Credit Management Server

The credit management server 2 serves to manage a credit relating to the vehicle 4. As shown in FIG. 1, the credit management server 2 includes the credit management system 21, a credit management DB 22, and a communication unit 23.

When there is a vehicle 4 that meets the engine start lock requirement among the vehicles 4 managed by the credit management DB 22, the credit management system 21 transmits information for identifying that vehicle 4 (e.g., the vehicle identification number (VIN number)) to the credit collection server 1.

The credit management DB 22 stores the information for identifying the vehicle 4 (e.g., the vehicle identification number (VIN number)) and information about a credit for the vehicle 4 (e.g., a loan credit or a lease credit).

The communication unit 23 is composed of, for example, an LAN interface board, a wireless communication circuit for wireless communication, etc. The communication unit 23 exchanges information with the credit collection server 1 through communication via the network N.

### Vehicle Information Server

The vehicle information server 3 includes a control unit 31, a vehicle information DB 32, and a communication unit 33.

The control unit 31 is realized by, for example, a processor that is formed by a CPU or the like and a memory (main storage unit) that is formed by an RAM, an ROM, or the like. According to a request from the credit collection server 1, the control unit 31 transmits a request for activation of the engine start lock to the vehicle 4. According to a request from the credit collection server 1, the control unit 31 transmits a request for the vehicle information to the vehicle 4. According to a request from the credit collection server 1, the control unit 31 transmits a request for cancelation of the engine start lock to the vehicle 4.

The vehicle information DB 32 stores the vehicle information acquired from the vehicle 4. According to a request from the credit collection server 1, the vehicle information DB 32 transmits the vehicle information to the credit collection server 1.

The communication unit 33 is composed of, for example, an LAN interface board, a wireless communication circuit for wireless communication, etc. The communication unit 33 exchanges information with the credit collection server 1, the credit management server 2, and the vehicle 4 through communication via the network N.

### Vehicle

The vehicle 4 is, for example, an ordinary engine vehicle (conventional vehicle), a hybrid electric vehicle (HEV), or a plug-in hybrid electric vehicle (PHEV). Or the vehicle 4 may be, for example, a fuel-cell electric vehicle (FCEV) or a battery electric vehicle (BEV). The vehicle 4 includes an ECU 41, the immobilizer 42, the positioning unit 43, and a communication unit 44.

The ECU 41 is an electronic control unit having, for example, a microcomputer composed of a CPU, an ROM, an RAM, etc. as a main component. According to a request from the vehicle information server 3, the ECU 41 transmits the vehicle information including at least vehicle position information to the vehicle information server 3.

The immobilizer 42 performs activation of the engine start lock or cancelation of the engine start lock based on control by the vehicle information server 3.

The positioning unit 43 detects a current position of the vehicle 4 by, for example, receiving electric waves from GPS satellites. The method for detecting the current position of the vehicle 4 is not limited to the method using the GPS satellites, and, for example, a method combining light detection and ranging/laser imaging detection and ranging (LiDAR) and a 3D map may be used.

The communication unit 44 is composed of, for example, a data communication module (DCM) etc. The communication unit 44 exchanges information with the vehicle information server 3 through communication via the network N.

### Lock Cancelation Application Device

The lock cancelation application device 5 serves to apply to the credit collection server 1 for cancelation of the engine start lock. Examples of the lock cancelation application device 5 include information processing terminals (personal computers, smartphones, etc.) that the user and the owner of the vehicle 4 own.

When transmitting a request for cancelation of the engine start lock to the credit collection server 1, the lock cancelation application device 5 may include, in this request for cancelation of the engine start lock, information on a clock time when cancelation of the engine start lock is desired that has been input by the user of the vehicle 4, a route from a current position of the vehicle 4 to a destination, or a required time from the current position of the vehicle 4 to the destination.

### Exchange of Information Among Lock Cancelation Application Device, Credit Collection Server, Vehicle Information Server, and Vehicle

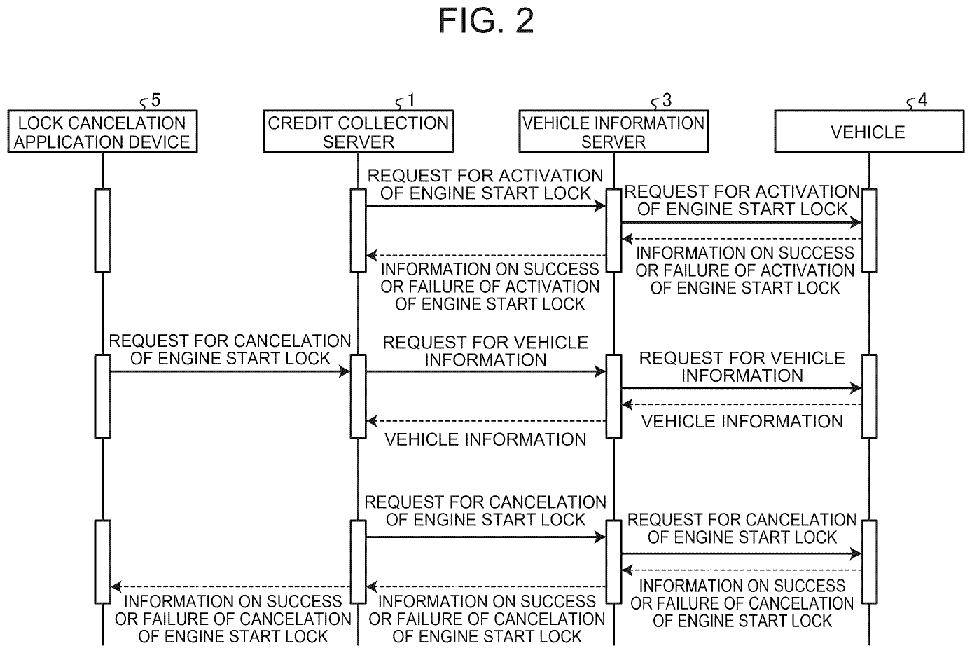

One example of exchange of information among the lock cancelation application device 5, the credit collection server 1, the vehicle information server 3, and the vehicle 4 will be described with reference to FIG. 2.

With meeting of the engine start lock requirement, for example, as a trigger, the credit collection server 1 transmits a request for activation of the engine start lock to the vehicle information server 3. Subsequently, the vehicle information server 3 forwards the received request for activation of the engine start lock to the vehicle 4. In response, the vehicle 4 performs activation of the engine start lock, and transmits information on success or failure of the activation of the engine start lock to the vehicle information server 3. Subsequently, the vehicle information server 3 forwards the received information on success or failure of the activation of the engine start lock to the credit collection server 1.

According to an operation of the user of the vehicle 4, for example, the lock cancelation application device 5 transmits a request for cancelation of the engine start lock to the credit collection server 1. In response, the credit collection server 1 transmits a request for the vehicle information to the vehicle information server 3. Subsequently, the vehicle information server 3 forwards the received request for the vehicle information to the vehicle 4. In response, the vehicle 4 transmits the vehicle information to the vehicle information server 3. Subsequently, the vehicle information server 3 forwards the received vehicle information to the credit collection server 1.

When the credit collection server 1 determines to permit cancelation of the engine start lock based on the received vehicle information, the credit collection server 1 transmits a request for cancelation of the engine start lock to the vehicle information server 3. Subsequently, the vehicle information server 3 forwards the received request for cancelation of the engine start lock to the vehicle 4. In response, the vehicle 4 executes cancelation of the engine start lock, and transmits information on success or failure of the cancelation of the engine start lock to the vehicle information server 3. Subsequently, the vehicle information server 3 forwards the received information on success or failure of the cancelation of the engine start lock to the credit collection server 1. Subsequently, the credit collection server 1 forwards the received information on success or failure of the cancelation of the engine start lock to the lock cancelation application device 5.

### Process in Credit Collection Server

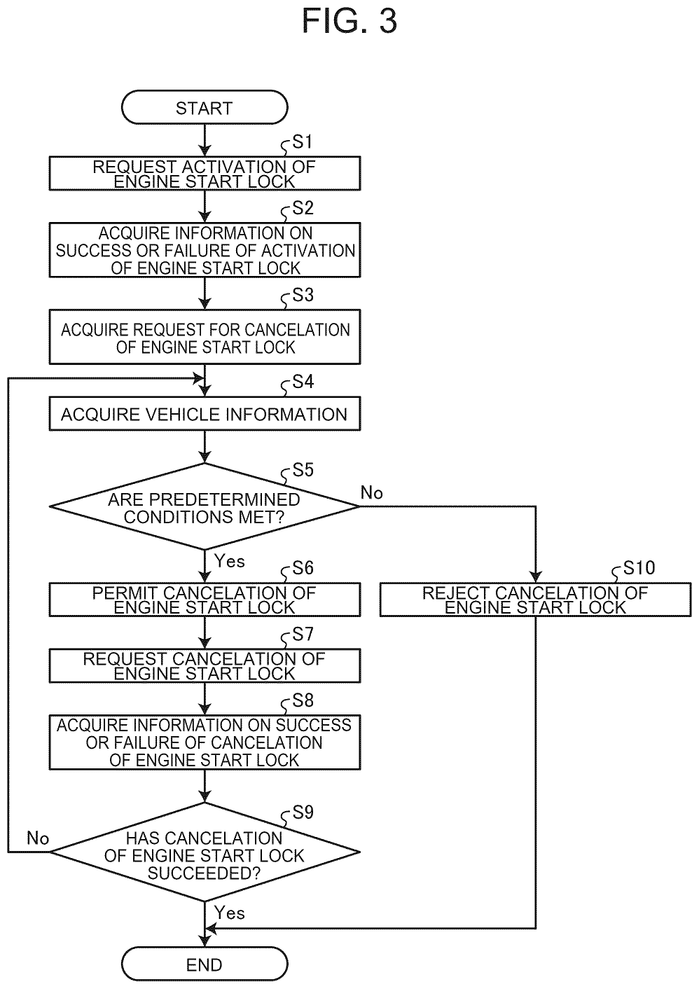

One example of the flow of a process in the credit collection server 1 will be described with reference to FIG. 3. The following description will be given based on a premise that the engine start lock requirement (e.g., the user defaulting on a debt) is met at the point of starting the process.

First, the control unit 11 transmits a request for activation of the engine start lock to the vehicle information server 3 (step S1). Thus, the request for activation of the engine start lock is forwarded from the vehicle information server 3 to the immobilizer 42.

Subsequently, the control unit 11 acquires information on success or failure of the activation of the engine start lock from the vehicle information server 3 (step S2). Subsequently, the control unit 11 acquires a request for cancelation of the engine start lock from the lock cancelation application device 5 (step S3).

Subsequently, the control unit 11 acquires the vehicle information from the vehicle information server 3 (step S4). Subsequently, the control unit 11 determines whether the predetermined conditions for cancelation of the engine start lock are met based on the acquired vehicle information (step S5).

When it is determined in step S5 that the predetermined conditions are met (Yes in step S5), the control unit 11 permits cancelation of the engine start lock (step S6), and transmits a request for cancelation of the engine start lock to the vehicle information server 3 (step S7). Thus, the request for cancelation of the engine start lock is forwarded from the vehicle information server 3 to the immobilizer 42.

Subsequently, the control unit 11 acquires the information on success or failure of the cancelation of the engine start lock from the vehicle information server 3 (step S8). Subsequently, the control unit 11 determines whether the cancelation of the engine start lock has succeeded based on the information on success or failure acquired in step S8 (step S9).

When it is determined in step S9 that the cancelation of the engine start lock has succeeded (Yes in step S9), the control unit 11 completes the current process. On the other hand, when it is determined in step S9 that the cancelation of the engine start lock has failed (No in step S9), the control unit 11 returns to processing of step S4. Examples of cases where cancelation of the engine start lock fails include a case where a request for cancelation of the engine start lock could not be transmitted from the vehicle information server 3 to the immobilizer 42 due to communication failure etc., and a case where the immobilizer 42 malfunctioned.

Here, when it is determined in step S5 that the predetermined conditions are not met (No in step S5), the control unit 11 rejects cancelation of the engine start lock (step S10) and completes the current process.

### Process 1 in Vehicle Information Server

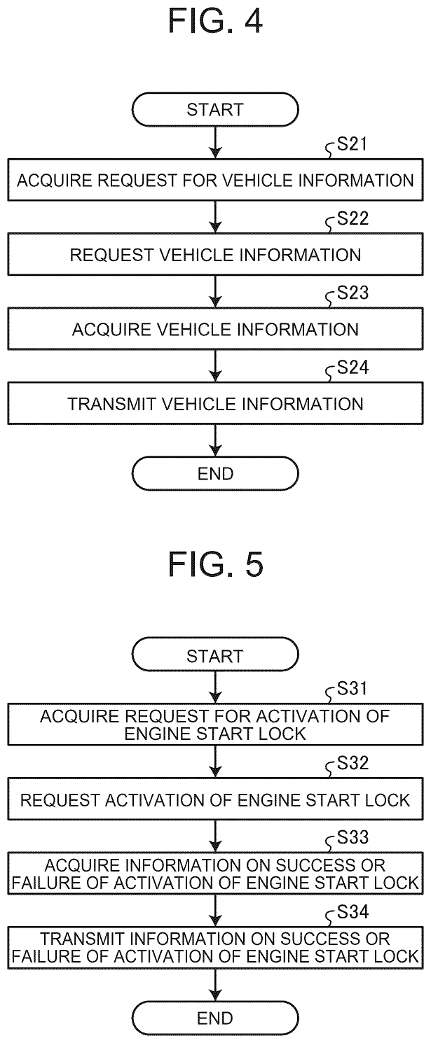

One example of a flow in the vehicle information server 3 when transmitting the vehicle information to the credit collection server 1 will be described with reference to FIG. 4.

First, the control unit 31 acquires a request for the vehicle information from the credit collection server 1 (step S21). Subsequently, the control unit 31 transmits the received request for the vehicle information to the vehicle 4 (step S22). Subsequently, the control unit 31 acquires the vehicle information from the vehicle 4 (step S23). Subsequently, the control unit 31 transmits the acquired vehicle information to the credit collection server 1 (step S24), and completes the current process.

### Process 2 in Vehicle Information Server

One example of a flow in the vehicle information server 3 when performing activation of the engine start lock of the vehicle 4 will be described with reference to FIG. 5.

First, the control unit 31 acquires a request for activation of the engine start lock from the credit collection server 1 (step S31). Subsequently, the control unit 31 transmits the received request for activation of the engine start lock to the vehicle 4 (step S32). Subsequently, the control unit 31 acquires information on success or failure of the activation of the engine start lock from the vehicle 4 (step S33). Subsequently, the control unit 31 transmits the acquired information on success or failure of the activation of the engine start lock to the credit collection server 1 (step S34), and completes the current process.

### Process 3 in Vehicle Information Server

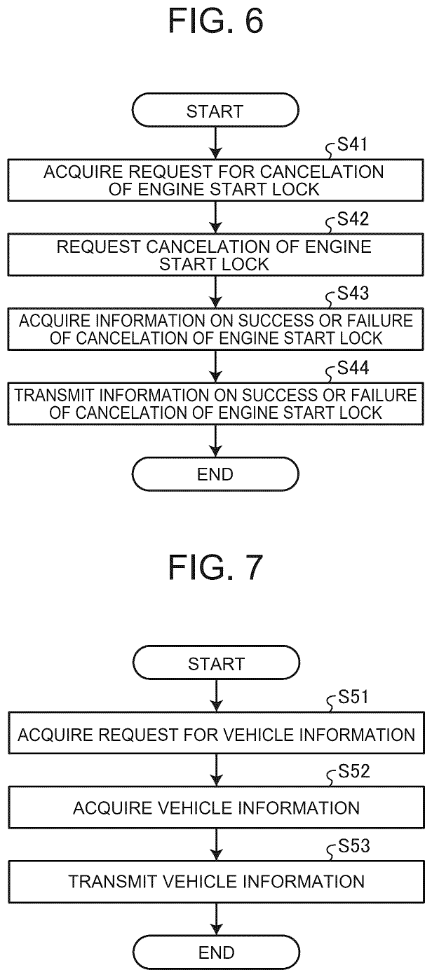

One example of a flow in the vehicle information server 3 when performing cancelation of the engine start lock of the vehicle 4 will be described with reference to FIG. 6.

First, the control unit 31 acquires a request for cancelation of the engine start lock from the credit collection server 1 (step S41). Subsequently, the control unit 31 transmits the received request for cancelation of the engine start lock to the vehicle 4 (step S42). Subsequently, the control unit 31 acquires information on success or failure of the cancelation of the engine start lock from the vehicle 4 (step S43). Subsequently, the control unit 31 transmits the acquired information on success or failure of the cancelation of the engine start lock to the credit collection server 1 (step S44), and completes the current process.

### Process 1 in Vehicle

One example of a flow in the vehicle 4 when transmitting the vehicle information to the vehicle information server 3 will be described with reference to FIG. 7.

First, the ECU 41 acquires a request for the vehicle information from the vehicle information server 3 (step S51). Subsequently, the ECU 41 acquires the vehicle information from the positioning unit 43 (step S52). Subsequently, the ECU 41 transmits the acquired vehicle information to the vehicle information server 3 (step S53), and completes the current process.

### Process 2 in Vehicle

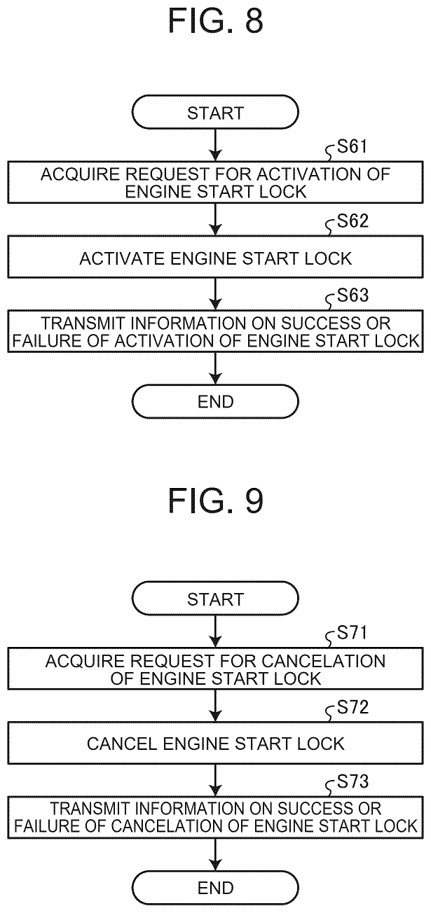

One example of a flow in the vehicle 4 when performing activation of the engine start lock will be described with reference to FIG. 8.

First, the ECU 41 acquires a request for activation of the engine start lock from the vehicle information server 3 (step S61). Subsequently, the ECU 41 performs activation of the engine start lock by controlling the immobilizer 42 (step S62). Subsequently, the ECU 41 determines whether the activation of the engine start lock has succeeded or failed based on, for example, a status of operation of the immobilizer 42, and transmits information on success or failure of the activation of the engine start lock to the vehicle information server 3 (step S63), and completes the current process.

### Process 3 in Vehicle

One example of a flow in the vehicle 4 when performing cancelation of the engine start lock will be described with reference to FIG. 9.

First, the ECU 41 acquires a request for cancelation of the engine start lock from the vehicle information server 3 (step S71). Subsequently, the ECU 41 performs cancelation of the engine start lock by controlling the immobilizer 42 (step S72). Subsequently, the ECU 41 determines whether the cancelation of the engine start lock has succeeded or failed based on, for example, the status of operation of the immobilizer 42, and transmits information on success or failure of the cancelation of the engine start lock to the vehicle information server 3 (step S73), and completes the current process.

### Process in Lock Cancelation Application Device

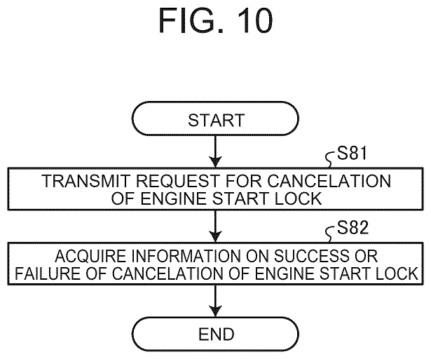

One example of a flow in the lock cancelation application device 5 when performing cancelation of the engine start lock will be described with reference to FIG. 10.

First, the lock cancelation application device 5 transmits a request for cancelation of the engine start lock to the credit collection server 1 (step S81). Subsequently, the lock cancelation application device 5 acquires information on success or failure of the cancelation of the engine start lock from the credit collection server 1 (step S82), and completes the current process.

In the case where the owner and the user of the vehicle 4 are different, after the owner has activated the engine start lock, the vehicle control device according to the embodiment having been described above temporarily permits cancelation of the engine start lock only when the user is in urgent need. Thus, minimum use of the vehicle 4 by the user and credit protection by the owner can be reconciled.

Further effects and modified examples can be easily derived by those skilled in the art. Therefore, broader aspects of the present disclosure are not limited to the specific detailed and representative embodiment that has been presented and described above. Thus, various changes can be made without departing from the sprit or scope of the general concept of the present disclosure that is defined by the attached claims and equivalents thereof.

For example, the description has been given based on the premise that the credit collection server 1 functions as the vehicle control device in the embodiment, but the vehicle 4 itself may function as the vehicle control device. In this case, the vehicle 4 may include the functions of the control unit 11 of the credit collection server 1 and the vehicle history DB 12. In the vehicle control device according to the embodiment, part of the processes in the credit collection server 1 and the vehicle information server 3 may be taken charge of by the vehicle 4.

For example, all of requesting activation of the engine start lock, requesting cancelation of the engine start lock, and determining whether to permit cancelation of the engine start lock may be performed in the credit collection server 1. All of requesting activation of the engine start lock, requesting cancelation of the engine start lock, and determining whether to permit cancelation of the engine start lock may be performed in the vehicle 4. Or requesting activation of the engine start lock and determining whether to permit cancelation of the engine start lock may be performed in the vehicle 4, and requesting cancelation of the engine start lock may be performed in the credit collection server 1.

While the credit collection server 1, the credit management server 2, and the vehicle information server 3 have been described as separate devices in the embodiment, the credit collection server 1, the credit management server 2, and the vehicle information server 3 may be formed by one, two, or four or more devices.

While generating a machine learning model (training phase) and determining whether to permit cancelation of the engine start lock (prediction phase) are performed in one device (credit collection server 1) in the embodiment, one of these phases may be performed in a separate device.

What is claimed is:

1. A vehicle control device comprising one or more processors configured to:
when a prespecified first requirement is met, activate engine start lock that prohibits starting of an engine of a vehicle;
after activating the engine start lock, acquire a second request for deactivating the engine start lock from a user of the vehicle who is different from an owner of the vehicle;
when the second request is acquired, determine whether to permit deactivation of the engine start lock based on a predetermined condition; and
when it is determined to permit deactivation of the engine start lock, deactivate the engine start lock.

2. The vehicle control device according to claim 1, wherein the predetermined condition includes a condition about a clock time or a period when the engine start lock is to be deactivated.

3. The vehicle control device according to claim 2, wherein the one or more processors are configured to determine to permit deactivation of the engine start lock when the clock time or the period when the engine start lock is to be deactivated is within a predetermined time.

4. The vehicle control device according to claim 1, wherein:
the predetermined condition includes information about a route from a current position of the vehicle to a destination; and
the one or more processors are configured to activate the engine start lock when the vehicle has traveled farther than a predetermined distance from the route after the one or more processors have deactivated the engine start lock.

5. The vehicle control device according to claim 1, wherein:
the predetermined condition includes information about a required time from a current position of the vehicle to a destination; and
the one or more processors are configured to activate the engine start lock when the vehicle has traveled a predetermined time longer than the required time after the one or more processors have deactivated the engine start lock.

6. The vehicle control device according to claim 1, wherein:
the predetermined condition includes information about the number of times that the engine start lock has been deactivated; and
the one or more processors are configured to permit deactivation of the engine start lock when the number of times that the engine start lock has been deactivated within a predetermined period is equal to or smaller than a predetermined number of times.

7. The vehicle control device according to claim 1, wherein a request for deactivation of the engine start lock is acquired from a terminal device that is possessed by the owner.

8. The vehicle control device according to claim 1, wherein a request for deactivation of the engine start lock is acquired from a terminal device that is possessed by the user.

9. The vehicle control device according to claim 1, wherein the determining whether to permit deactivation of the engine start lock based on the predetermined condition includes determining whether to permit deactivation of the engine start lock by inputting a clock time or a period when the engine start lock is to be deactivated into a machine learning model that has been generated through training using, as a feature amount, a clock time or a period when the engine start lock is to be deactivated and, as a correct label, information about whether to permit deactivation of the engine start lock.

10. The vehicle control device according to claim 1, wherein the one or more processors are configured to:
acquire, from the user, a first clock time when deactivation of the engine start lock of the vehicle is to be started; and
when the first clock time is within a predetermined time, deactivate the engine start lock.

11. The vehicle control device according to claim 10, wherein the one or more processors are configured to:
acquire, from the user, a second clock time when deactivation of the engine start lock of the vehicle is to be ended; and
when the second clock time is within a predetermined time, deactivate the engine start lock.

12. The vehicle control device according to claim 1, wherein:
the predetermined condition includes a condition about a position of the vehicle; and
the one or more processors are configured to deactivate the engine start lock when the position of the vehicle is a predetermined position.
